(19) United States
(12) Patent Application Publication
(10) Pub. No.: US 2008/0290693 A1
(43) Pub. Date: Nov. 27, 2008

(54) Device for Protecting Passengers in a Motor Vehicle in the Event of Energy Input Caused by a Collision and Oriented at the Motor Vehicle Door

(76) Inventors: Tobias Melz, Darmstadt (DE); Bjorn Seipel, Florstadt (DE); Bernhard Sielhorst, Sontra (DE); Eric Zimmerman, Kassel (DE)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/817,975

(22) PCT Filed: Feb. 17, 2006
(86) PCT No.: PCT/EP2006/001472

§ 371 Date: Jun. 6, 2008

(30) Foreign Application Priority Data
Mar. 9, 2005 (DE) 10 2005 011 162.9

(51) Int. Cl. B60R 27/00

(52) U.S. Cl. 296/187.12

(57) ABSTRACT

The invention is a device for protecting passengers in a motor vehicle in the event of energy input caused by a collision oriented laterally at a motor vehicle door. The device is provided with a connection structure comprising at least two parts, a first part and a second part of which the first part is firmly connected to the motor vehicle door and the second part is firmly connected to an energy-absorbing region of the motor vehicle chassis. the two parts can be brought into an interactive effects connection via at least one common joint region to selectively divert at least a part of the energy input acting laterally to the motor vehicle chassis. The first and/or second part are at least partially provided with a transducer material which undergoes a mechanical change in state as a result of energy application as in a change in shape by means of which the two parts are brought to contact and/or interlock, the second part of the connection structure being affixed in a motor vehicle chassis region directly surrounding the motor vehicle door.

### BACKGROUND OF THE INVENTION

1. Field of the Invention

The present invention relates to a device for protecting passengers in a motor vehicle in the event of energy input caused by a collision and oriented at the motor vehicle door.

2. Description of the Prior Art

Protecting passengers in motor vehicles is one of the main aims in motor vehicle construction and development. A particular development goal is designing crush zones in the front and rear of the car capable of protecting the passenger cabin with a great degree of certainty. However, in lateral collisions, passenger protection presents major problems due to the short available deformation paths and the low absorption capacities of the lateral structure of a motor vehicle. Prior art solutions to reduce the danger for the passengers in lateral collisions of motor vehicles provide for reinforcing the motor vehicle door. For example, known are moldings possessing great rigidity and/or great energy absorption capacities which are integrated in the motor vehicle door. For example DE 196 33 637 A1 describes a motor vehicle door with lateral impact protection, in the door frame of which curved grip rods are provided which twist upon onset of a collision in such a manner that under tension stress they deform to act like a catch net.

Such reinforcement of the side doors by providing corresponding longitudinal bars, however, does not always suffice to protect the passengers, because when external forces act on the side door it can be pressed right through the chassis door opening in such a way that the passenger survival space is drastically reduced as are the passengers' chances of survival.

Moreover, the state of the art knows a series of measures that are suited to convey the forces acting on the side door to the chassis. For example, by means of correspondingly great overlapping between the door and the door opening or by means of bolts projecting from the edge of the door which engage in reinforced recesses in the chassis door opening upon onset of a collision. DE AS 22 15 674 describes a motor vehicle door reinforcement means essentially comprising an outward bulging bar whose end sections enter stretched into correspondingly strong recesses upon deformation of the bar due to an external impact. The bar is preferably composed of corrugated steel sheet which is usually formed into the corresponding shape.

In order to avoid increasing the weight of the motor vehicle as a consequence of the preceding measures, DE 41 25 299 C2 describes a motor vehicle door reinforcement means comprising, to reduce weight, a curved bar reinforcement composed of a fiber-reinforced composite material. In this case the reinforcement means is located completely inside the door. The reinforcement means only comes out of the door on both sides with its end regions upon deformation of the reinforcement bar upon onset of a collision. The end regions for their part provide an effective connection with the stable support flanks in the chassis door frame.

DE 196 39 519 A1 describes a passenger cabin that provides as a means of protecting passengers in lateral collisions a transverse bar construction which produces a rigid transverse connection between the vehicle door and the middle console in such a manner that the seat area is protected against the vehicle door regions being pushed into the passenger cabin. The transverse construction only appears upon the onset of a collision in that pyrotechnical or pneumatic actors extend the articulated transverse construction, which is normally integrated in the lining of the seat, door and middle console, forming a stable transverse connection.

### SUMMARY OF THE INVENTION

Based on the aforedescribed prior art, the object of the present invention is to provide a safety system which optimizes passenger protection and which upon the onset of a lateral impact or a collision situation similar to a lateral impact is able to provide greater protection for the passengers. In particular, the object is to improve the safety system in such a manner that the deformation energy acting on the motor vehicle door upon the onset of a lateral collision is selectively conveyed safely away from the region of the vehicle door to ultimately prevent too great a reduction of the passenger space due to the collision-based deformation of the motor vehicle door, and parts of the door injuring the passengers upon cave in.

The device for protecting passengers in a motor vehicle in the event of energy input caused by a collision and oriented laterally at the motor vehicle door is provided with a connection structure comprising at least two parts, a first and a second part, of which the first part is firmly connected to the motor vehicle door and the second part is firmly connected to an energy-absorbing region of the motor vehicle chassis and the two parts can be brought to interact in an interactive effective connection via at least one common joint region for selective deflection of at least one part of the lateral energy input acting laterally on the motor vehicle door, and the first and/or second part is at least partly provided with a transducer material which due to the energy input undergoes a mechanical change, in particular, in the form of a change in shape by means of which the two parts are to be brought into contact and/or interlocked and that the second part of the connection structure is affixed in a region of the motor vehicle chassis directly surrounding the motor vehicle door,

Contrary to the state-of-the-art solutions to increase the rigidity of the motor vehicle door described at the beginning, in which lateral impact bars extending through the motor vehicle door are provided and which in the event of a lateral collision push into the more stable regions of the chassis in order in this manner to divert the crash energy oriented at the motor vehicle door in the extreme case transversely to the action direction, according to printed publications DE-AS 2 215 674 and DE 196 33 637 A1, the invention provides at least one stable connection structure which is only connected locally in the peripheral region of the motor vehicle door and upon the onset of a collision develops a stabilizing effect on the motor vehicle door in that upon onset of a collision, the first part connected to the motor vehicle door enters a stable intimate connection with the second part of the connection structure affixed in the stable frame construction directly surrounding the closed motor vehicle door. Surprisingly, it was proven that the crash energy input acting laterally on the motor vehicle door can be effectively deflected without using complicated lateral impact bar constructions, usually extending through the motor vehicle door on the inside, but only by the provision of one or a multiplicity of connection structures affixed distributed around the motor vehicle door. The crash energy input acting laterally on the motor vehicle door is deflected via the connection structures into the stable chassis frame region without critical deformation of the door, i.e. at least not to a greater degree than is the case when lateral impact bars are employed. Thus if a crash occurs thus upon locking, the two, three or more corresponding connection structures placed around the motor vehicle door act as a clamping means that firmly clamps the motor vehicle door inside the chassis frame thereby granting the motor vehicle door considerable inherent rigidity and enabling it to intercept to a large extent the energy input acting on the door from the outside and, in addition, to divert the input energy via the connection structures into the stable chassis frame. This knowledge contributes to considerably simplifying the measures for protecting against lateral impact and thereby decisively contributes to reducing weight and costs, compared to previous solutions, with the same or improved protection properties.

Another special property of the device is that by selectively using a transducer material in the region of the connection structure, in the ideal case, the functionality of the door remains unimpaired, that is the door can still be opened and closed as before. On the one hand, a flush connection structure between the motor vehicle door and the motor vehicle chassis when the door is closed has a stable support function upon the onset of an acting energy input when a crash occurs. On the other hand, the recurrable locking and unlocking permits coupling with progressive, so-called precrash sensors, for example in the form of optical or radar-based sensors which may provide technically based misinformation about the critical extent of the detected situation. Thus more extensive analyses and evaluation are required to verify the detection of an imminent crash, thereby, further reducing the reaction time, for example for locking. The described reversibility renders possible misinformation to be tolerable and results in increased overall safety. There are several embodiments to realize the connection structure that meets these demands.

In the simplest case, the first and second part is entirely or partly made of a transducer material and activated accordingly upon the onset of a collision. Fundamentally, a multiplicity of different state-of-the-art transducer materials can be employed, preferably solid transducer materials such as piezo ceramics, electrostrictive ceramics, shape-memory alloys (SMA). Such transducer materials permit direct use given a predetermined shape suited for the connection structure of the parts connected to the motor vehicle door and to the interior region of the motor vehicle chassis.

Furthermore, fluid transducer materials, such as for example piezo polymers, electrorheological fluids, polymer gels and magnetorheological fluids are also known which under circumstances are also suited, if provided in a suitably selected casing, for use in the connection structure.

Using transducer materials in the connection structure permits selective adjustment of the rigidity and the dampening behavior of the parts entering into an interactive effect connection upon the onset of a collision and in this way to selectively adjust the crash relevant and passenger relevant chassis door system. For example, transducer materials composed of form memory materials are able to alter their shape in a certain way by means of selective application of electrical current and the accompanying rise in temperature and at the same time also to influence the material rigidity and/or material dampening properties. This property is advantageously employed by the invention in that a connection structure composed of a shape-memory material and provided with at least one joint region of two separable parts or sections can be activated upon onset of a crash situation by means of selective application of electric energy in such a manner that the two parts enter a intimate, stable interactive effective connection via which the crash energy acting along the connection direction is selectively diverted into a stable chassis frame region directly adjacent to the motor vehicle door.

In addition to the function of selective diversion of force along the connection structure, the employed transducer material permits altering its rigidity behavior, respectively its dampening behavior, by means of actively controlling an energy form selectively acting on the transducer material, for example in the form of electrical, thermal or similar energy, with the purpose of reducing the physiological stress on the passengers in the motor vehicle. Regulation, control of the rigidity behavior, and of the dampening behavior of the employed transducer material can occur under various target functions, for example with the purpose of reducing the whiplash of the passengers inside the motor vehicle. The target function basically depends on the age, weight, sex, size and the respective sitting position of the passengers inside the motor vehicle.

The invention can, of course, also be successfully used not only in the side doors of a motor vehicle, but rather the connection structure is also suited for stabilizing a hatch door.

In order to further improve the stability properties of motor vehicles in a crash, another embodiment provides additional reinforcement, respectively stiffening the motor vehicle door using a plate-shaped element or a plane component which is placed on the exterior and/or interior side of the motor vehicle door, of course, in such a manner that it is not noticeable from the outside and which is connected with the first part of the connection structure in order to in this manner, upon the onset of a collision, divert all the force input acting on the plane element directly via the first part and connected thereto via the second part of the connection structure into the stable chassis frame region. As an alternative to such plane components, the rigidity of the door can also be increased by means of bar structures inside the door. In contrast to the lateral impact bars which extend through the entire motor vehicle door, the bar structures are designed to be small and are only able to stabilize sections of the motor vehicle door, for example the lower corner regions of the motor vehicle door. Further details are given in the description with reference to the described preferred embodiments.

The additional plane elements and bar structures serving to improve the rigidity of the motor vehicle door should be composed of robust and as light-weight as possible materials, for example light metals or also fiber-reinforced synthetic materials. Feasible is also using transducer materials in order to also influence the dampening and rigidity behavior of these components.

In the case of side doors, it has proven to be especially advantageous that the part of the connection structure which is connected to the stable chassis interior region is in a fixed interactive effect connection with the chassis in the region below the motor vehicle seat. Such anchoring of the connection structure provided in the interior of the motor vehicle chassis has an especially physiologically lessening effect on the passengers seated in the respective motor vehicle seat in crash situations, in particular in instances in which the connection structure is composed of the aforedescribed transducer materials with their adjustable dampening and stiffness behavior.

The aforedescribed embodiment of the connection structure using transducer materials, however, does not necessarily presuppose activation of the respective material by means of externally applied energy, such as for example application of electrical energy. It is also possible to use the aforedescribed connection structure in an advantageous manner solely passively. For instance a connection structure composed of shape-memory material permits production-based respectively material-based adjustment of the rigidity and/or dampening course by corresponding utilization of the material-inherent properties (for example, super elasticity or material hysteresis) by means of which predetermined adaptation of the energy input acting on the motor vehicle chassis, thus on the passengers seated in the motor vehicle seat when a lateral impact occurs, is possible.

Selective quasi-static adjustment of the material properties, respectively component properties analogous to the above description is also feasible. For example, if employing shape-memory metals it is feasible to utilize the thermal activation for variable adjustment of the material hysteresis.

Furthermore, it is feasible to utilize the crash energy itself to produce the joint connection. For instance, the crash energy can be used to lock the parts of the connection structure. An active element can effect subsequent separation of the parts to permit, respectively facilitate, opening the door and rescuing the passengers.

It is also just as feasible to utilize the crash energy to activate the transducer material. In the case of shape-memory metal, the mechanical energy can be converted into thermal energy by means of which the actual activation of the shape memory effect is achieved.

Moreover, also feasible are preferred embodiments which provide a more complexly designed connection structure. Thus it is feasible to design the first and second part of the connection structure double in such a manner that a parallel arrangement of first and second parts entering an interactive effect connection is possible. The first part can be designed as a pipe with a separate rod running inside; the two components can be composed of different materials. As an alternative or in combination with the preceding variant, the second part can also be divided in two in the longitudinal direction, with one region being composed of a transducer material and the other of a conventional material. The preceding reflections are intended to show that there are almost no limits to the manifold designing possibilities of the connection structure to optimize the connection structure with the aim of effectively diverting, respectively absorbing the crash energy from the region of the motor vehicle door.

In order to make the device for protecting passengers in a motor vehicle in the event of energy input caused by a collision and oriented at the motor vehicle door more apparent reference is made to the following single preferred embodiment with reference to the figure.

### BRIEF DESCRIPTION OF THE DRAWINGS

The present invention is made more apparent in the following by way of example without the intention of limiting the scope or spirit of the overall inventive idea with reference to the accompanying drawings.

FIG. 1 shows a schematic lateral view of a motor vehicle with A, B and C columns,

FIGS. 2a, b, and c show a lateral view of a motor vehicle front door with various modes of affixing connection structures.

### DETAILED DESCRIPTION OF THE INVENTION

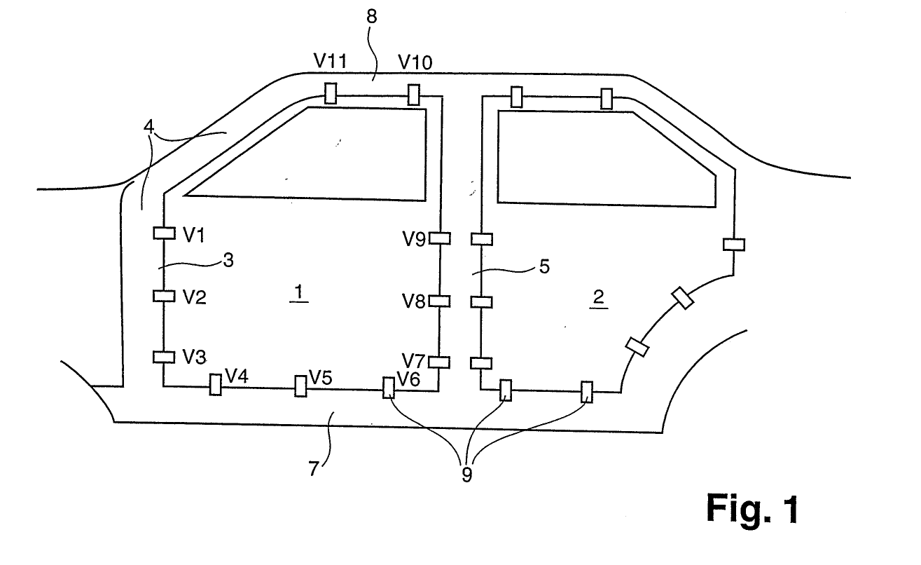

FIG. 1 shows a schematic lateral representation of a motor vehicle with a front and a rear door 1, 2. The front motor vehicle door 1 is hinged in the usual manner along its front edge 3 in a swinging manner about the A column 4. Like the front motor vehicle door 1, the rear motor vehicle door 2 is hinged along its front edge 5 in a swinging manner to the B column 6 of the motor vehicle. Its is to be noted that the measures for increasing the inherent rigidity of the motor vehicle doors 1 and 2 described in the following are to be viewed independent of the respective hanging of the motor vehicle door to a stable motor vehicle chassis, which in each case provides a motor vehicle frame region which completely surrounds the motor vehicle door in a closed state and which in the case of front motor vehicle door 1 comprises the regions A column 4, roof edge region 8, B column 6 and the floor threshold region 7.

In order to improve the inherent rigidity of a motor vehicle door, according to the present invention, the motor vehicle door 1 and 2 is firmly connected to the stable chassis frame at certain local points upon onset of a crash in such a manner that the motor vehicle door is really firmly clamped in the chassis frame structure surrounding the motor vehicle door via the so-called connection structures 9. Each single connection structure 9 comprises two parts, of which a first part T1 is firmly connected to the motor vehicle door and a second part T2 is firmly connected to the chassis frame region directly opposite the motor vehicle door. In normal operation, the two parts T1 and T2 are decoupled in such a manner that normal door operation is not impeded. The two parts are joined only upon the onset of a collision and preferably interlock.

For separable firm locking of the two parts T1 and T2, at least one of the two parts is provided with a transducer material which undergoes a mechanical change in state in the form of a change in shape by means of which the two parts T1 and T2 can contact, preferably can interlock.

The points shown in FIG. 1 at which the connection structures 9 are affixed to the front as well as to the rear motor vehicle door 1 and 2 are fundamentally all the preferred sites along the surrounding frame of the respective motor vehicle door at which the connection structures 9 are provided. In order to distinctly improve the inherent stability of a motor vehicle door, it suffices to only provide a single connection structure 9, preferably in the region of the lower right corner of the motor vehicle door, see for example the site of the connection structure V6 or V7. Depending on the stability requirements and the door design, one or a multiplicity of such connection structures can be affixed at the regions around the motor vehicle door indicated in FIG. 1. For example, in order to clamp the front motor vehicle door completely inside the chassis frame surrounding the motor vehicle door, it suffices to affix the following connection structures V2, V5, V8, V11. Also possible are, of course, any desired other possible combinations of the proposed connection structures V1 to V11 relating to both the front door and the rear door.

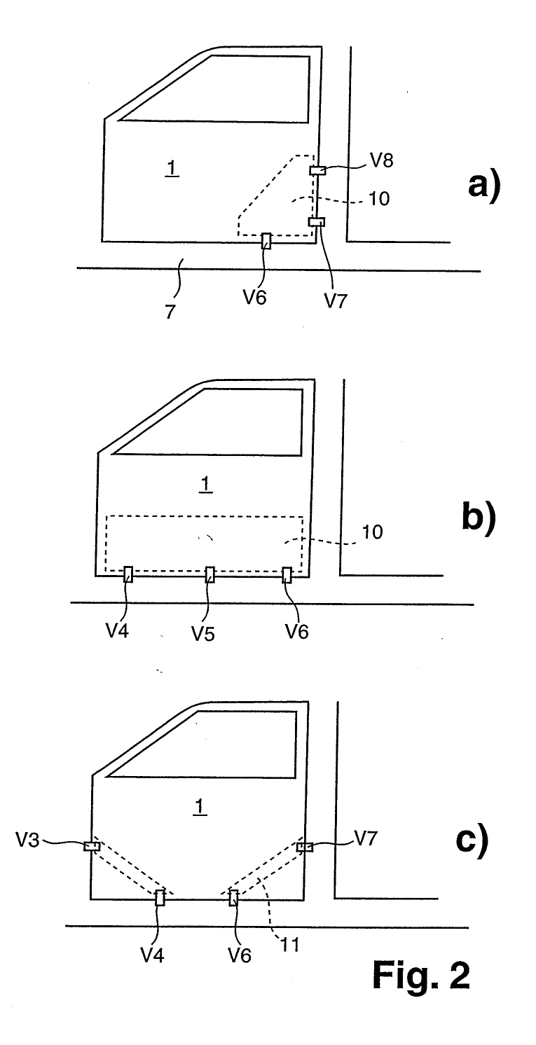

Particularly advantageous is combining the respective connection structures with an additional stabilizing element 10, according to the depiction in FIG. 2a, to be affixed to the motor vehicle door. FIG. 2a like the depiction of FIGS. 2b and 2c shows a schematisized front motor vehicle door 1, which according to the detail is engaged in an effect connection with the B column 6 and the floor threshold region 7 of a not further illustrated motor vehicle chassis. The stabilizing element 10 is preferably designed as a plane element and is able to stabilize the exterior side of the motor vehicle door from inside the door. It is also feasible that the stabilizing plane element 10 is designed as part of the exterior or interior side of the motor vehicle door.

The parts T1 of the connection structures 9 connected to the motor vehicle door is connected to this stabilizing element 10. In the preferred embodiment according to FIG. 2a, the lower right section of the motor vehicle door 1 is reinforced with a plane element 10 on which three connection structures V6, V7 and V8 are affixed. In the preferred embodiment according to FIG. 2b, the plane element 10 extends in the lower region over the entire longitudinal extension of the motor vehicle door and is connected via the connection structures V4, V5 and V6 to the floor threshold region 7.

As an alternative to the design of a plane element 10, it is also possible to improve the rigidity of the motor vehicle door by means of bar structures 11 located inside the door, which running diagonally in the preferred embodiment of FIG. 2c are able to stabilize the front and rear lower region of the motor vehicle door. In this case, too, the bar structures 11 are each connected to the connection structures V3,V4 as well as V6 and V7.

By providing a multiplicity of such connection structures V1-V11, it is possible upon onset of a collision to individually select the connection rigidity between the respective parts T1 and T2 of the connection structures 9 by means of different triggering of the transducer material and to do this dependent on the respective accident situation. Thus it is possible to influence the plane rigidity of the motor vehicle door in order to ensure as optimum as possible passenger protection. The accident situation can be detected with the aid of suited precrash sensors and an individually predetermined rigidity inside the motor vehicle door can be generated by means of individual triggering of the transducer materials present in the connection structures.

It is also possible to produce, if needed, additionally provided stabilizing elements 10 composed of a transducer material or at least partly of a transducer material in order to selectively influence these components. Fundamentally influence can be exercised on the dampening and rigidity behavior of these components by triggering the transducer materials, by means of which the dynamics with which the crash energy acts on the motor vehicle door can be influenced. In this manner, the force moments acting crash-based physiologically on the passengers can be distinctly reduced.

The device according to the invention uses the ability of the inherent stability of the motor vehicle door to be considerably increased, if upon onset of a collision, the motor vehicle door enters at certain points along its peripheral edge rigid or intelligent controllable rigid connections with the stable chassis surrounding the motor vehicle door.

### LIST OF REFERENCES

1 Front motor vehicle door
2 Rear motor vehicle door
3 Front side edge of the motor vehicle door
4 A column
5 Front side edge of the rear motor vehicle door
6 B column
7 Floor threshold
8 Roof edge region
9 Connection structure
10 Stabilizing element, plane element
11 Bar structure

1-16. (canceled)

17. A device for protecting passengers in a motor vehicle upon an input of energy caused by a collision oriented laterally to a motor vehicle door, comprising:
a connection structure comprising at least two parts, a first part and a second part, the first part being connected to the motor vehicle door and the second part being connected to an energy-absorbing region of a chassis of the motor vehicle, and the two parts being connectable by at least one common joint region to selectively divert at least a part of the input of energy laterally to the chassis of the motor vehicle; and wherein
the first and/or second part are at least partially provided with a transducer material which undergoes a mechanical state change as a result of the input of energy which causes a change in shape so that the two parts are brought to contact and/or interlock and the second part of the connection structure is affixed in a region of the motor vehicle chassis directly surrounding the motor vehicle door.

18. A device according to claim 17, wherein:
when the motor vehicle door is closed, the first part of the connection structure is disposed directly opposite the second part.

19. A device according to claim 18, wherein:
at least one connection structure is disposed at one of the following regions of the motor vehicle and at the motor vehicle chassis surrounding the motor vehicle door:
along a column in a lower, middle or upper region;
along another column in the lower, middle or upper region;
along a floor threshold in a front, middle or rear region; and
along an edge of a roof in the front or rear region.

20. A device according to one of the claim 17, wherein:
the motor vehicle door is provided with a stabilizing element at least in a region of the connection structure.

21. A device according to claim 20, wherein:
the stabilizing element is a plane element reinforcing an exterior and/or interior side of the motor vehicle door or a bar-shaped support structure inside the motor vehicle door.

22. A device according to claim 20, wherein:
the first part of the connection structure is connected to the stabilizing element.

23. A device according to claim 21, wherein:
the first part of the connection structure is connected to the stabilizing element.

24. A device according to claim 20, wherein:
at least a section of the stabilizing element comprises a transducer material.

25. A device according to claim 21, wherein:
at least a section of the stabilizing element comprises a transducer material.

26. A device according to claim 22, wherein:
at least a section of the stabilizing element comprises a transducer material.

27. A device according to claim 17, wherein:
the first and the second part have joint contours which conform to each other in the at least one common joint region.

28. A device according to claim 27, wherein:
the joint connection of the first part at least partially surrounds the joint contour of the second part in the joint region or partly penetrates the second part.

29. A device according to claims 17, wherein:
the two parts of the connection structure are brought to contact in the at least one common joint region by closing the motor vehicle door.

30. A device according to claim 17, wherein:
the two parts, when in contact, are interlockable and unlockable.

31. A device according to claim 17, wherein the transducer material comprises at least one of the following:
piezo ceramics, piezo polymer, electrorestrictive ceramics, electrorheological fluid, polymer gel, magnetorheological fluid, shape-memory alloy, shape-memory polymer.

32. A device according to claim 17, wherein:
the first and/or second parts or at least sections of the first and/or second parts comprise a transducer material which undergoes a change in shape directly before and during the input of energy to cause the two parts become a separable fixed connection.

33. A device according to claim 17, comprising:
an approach sensor system associated with the motor vehicle which detects a collision situation and generates a signal causing at least sections of the transducer material to be activated.

34. A device according to claim 17, wherein:
the mechanical state change influences a vibration and/or dampening behavior of the transducer material.

35. A device according to claim 17, comprising:
an energy supply for the transducer material which is independent of the input of energy.

36. A device according to claims 27, wherein:
the two parts of the connection structure are brought to contact in the at least one common joint region by closing the motor vehicle door.
